(19) United States
(12) Patent Application Publication
(10) Pub. No.: US 2015/0356091 A1
(43) Pub. Date: Dec. 10, 2015

(54) METHOD AND SYSTEM FOR IDENTIFYING MICROBLOG USER IDENTITY

(71) Applicants: PEKING UNIVERSITY FOUNDER GROUP CO., LTD., Beijing (CN); PEKING UNIVERSITY, Beijing (CN); BEIJING FOUNDER ELECTRONICS CO., LTD., Beijing (CN)

(72) Inventors: Liyong ZHAO, Beijing (CN); Xiaoming YU, Beijing (CN); Jianwu YANG, Beijing (CN); Yan ZHENG, Beijing (CN)

(73) Assignees: PEKING UNIVERSITY FOUNDER GROUP CO., LTD., Beijing (CN); PEKING UNIVERSITY, Beijing (CN); BEIJING FOUNDER ELECTRONICS CO., LTD., Beijing (CN)

(21) Appl. No.: 14/760,048

(22) PCT Filed: Dec. 5, 2013
(86) PCT No.: PCT/CN2013/088616

§ 371 Date: Jul. 9, 2015

(30) Foreign Application Priority Data
Jan. 9, 2013 (CN) 201310008156.X

(51) Int. Cl. G06F 17/30

(52) U.S. Cl. CPC G06F 17/3053; G06F 17/30598

(57) ABSTRACT

Provided are a method and system for identifying microblog user identity. The method comprises obtaining behavioral data of a user to be identified and feature library information of user behavior, reprocessing the obtained behavioral data of the user to be identified, performing semantic unit reconstruction on the preprocessed user behavioral data, and obtaining attribute information and its corresponding weight of the semantic unit; obtaining behavioral feature of the user to be identified based on attribute information and corresponding weight. The method further comprises comparing behavioral feature of user to be identified with each feature category in the feature library information of user behavior and determining the identity of the user to be identified of user behavior exceeds a predefined threshold. Using the provided method and system for identifying the microblog user identity, the accuracy and real-time performance of identifying the microblog user identity may be effectively improved.

### CROSS-REFERENCE TO RELATED APPLICATIONS

This application is a national application of PCT/CN2013/088616, filed on Dec. 5, 2013, which is incorporated herein by reference in its entirety.

### BACKGROUND

1. Technical Field

The present disclosure relates to the field of computer information processing techniques, and in particular, to a method and system for identifying microblog user identity.

2. Description of the Related Art

With the advance of the web technique and the emergence of the microblogging, users in increasing numbers join the Internet and become members of the virtual community, which promotes the transformation of information dissemination and improves the efficiency of information dissemination. However, the identification of microblog user identity, which is an important part of the microblog background maintenance, is performed mainly through the data information registered and stored on the network by the microblog user. The microblog user identity may be identified, for example, by acquiring from the website the log of visiting the website, temporary information and registration information for the user to be identified; or, by the Chinese text classification method.

However, the present inventors have found that, in the existing process of the identification of microblog user identity, there is at least the following problem:

In the prior art, the identification of microblog user identity is achieved by acquiring temporary information, registration information and website access log of the user to be identified via the website. The identification of the user identity is mainly based on the data such as the temporary information, the registration information and the log of the user obtained from the website, but it is difficult to obtain such data and the accuracy of the data is low.

In the case that the identification of the microblog user identity is achieved by the Chinese text classification method in the prior art, the accuracy and real-time performance of such identification of the microblog user identity are not satisfactory at present.

### SUMMARY OF THE INVENTION

In view of the defects existing in the prior art as described above, one object of the present disclosure is to provide a method and system for identifying microblog user identity with high accuracy and good real-time ability.

The present disclosure provides a method for identifying microblog user identity, comprising steps of:

obtaining behavioral data of a user to be identified and feature library information of user behavior;

preprocessing the obtained behavioral data of the user to be identified;

performing semantic unit reconstruction on the preprocessed user behavioral data;

obtaining attribute information and its corresponding weight of the semantic unit;

obtaining behavioral feature of the user to be identified, based on the attribute information and its corresponding weight of the semantic unit;

comparing the behavioral feature of the user to be identified with each feature category in the feature library information of user behavior;

determining the identity of the user to be identified, in the case that the similarity between the behavioral feature of the user to be identified and one feature category in the feature library information of user behavior exceeds a predefined threshold.

The present disclosure also provides a system for identifying microblog user identity, comprising:

information obtaining unit, configured for obtaining behavioral data of a user to be identified and feature library information of user behavior;

preprocessing unit, configured for preprocessing the obtained behavioral data of the user to be identified;

semantic unit reconstruction unit, configured for performing semantic unit reconstruction on the preprocessed user behavioral data;

attribute and weight information obtaining unit, configured for obtaining attribute information and its corresponding weight of the semantic unit;

behavioral feature extracting unit, configured for obtaining behavioral feature of the user to be identified, based on the attribute information and its corresponding weight of the semantic unit;

comparing unit, configured for comparing the behavioral feature of the user to be identified with each feature category in the feature library information of user behavior;

identity determining unit, configured for determining the identity of the user to be identified, in the case that the similarity between the behavioral feature of the user to be identified and one feature category in the feature library information of user behavior exceeds a predefined threshold.

In the present disclosure, the provided method and system for identifying the microblog user identity obtain behavioral data of a user to be identified and feature library information of user behavior; preprocess the obtained behavioral data of the user to be identified; perform semantic unit reconstruction on the preprocessed user behavioral data; obtain attribute information and its corresponding weight of the semantic unit; obtain behavioral feature of the user to be identified, based on the attribute information and its corresponding weight of the semantic unit; compare the behavioral feature of the user to be identified with each feature category in the feature library information of user behavior; determine the identity of the user to be identified, in the case that the similarity between the behavioral feature of the user to be identified and one feature category in the feature library information of user behavior exceeds a predefined threshold. Using the provided method and system for identifying the microblog user identity, the accuracy and real-time performance of identifying the microblog user identity may be effectively improved.

### BRIEF DESCRIPTION OF THE DRAWINGS

FIG. 1 is a flowchart showing a method for identifying microblog user identity according to an exemplary embodiment of the present disclosure;

FIG. 2 is a flowchart for constructing a feature library of user behavior in a method for identifying microblog user identity according to the present disclosure;

FIG. 3 is a flowchart for updating the feature library of user behavior in the method for identifying microblog user identity according to the present disclosure;

FIG. 4 is a schematic diagram showing a structure of a system for identifying microblog user identity according to an exemplary embodiment of the present disclosure;

FIG. 5 is a schematic diagram showing another structure of a system for identifying microblog user identity according to an exemplary embodiment of the present disclosure; and

FIG. 6 is a schematic diagram showing a structure of attribute information data of semantic unit used in a method for identifying microblog user identity according to an exemplary embodiment of the present disclosure.

### DESCRIPTION OF THE EMBODIMENTS

Methods and systems for identifying microblog user identity according to exemplary embodiments of the present disclosure will be described in detail below with reference to the drawings.

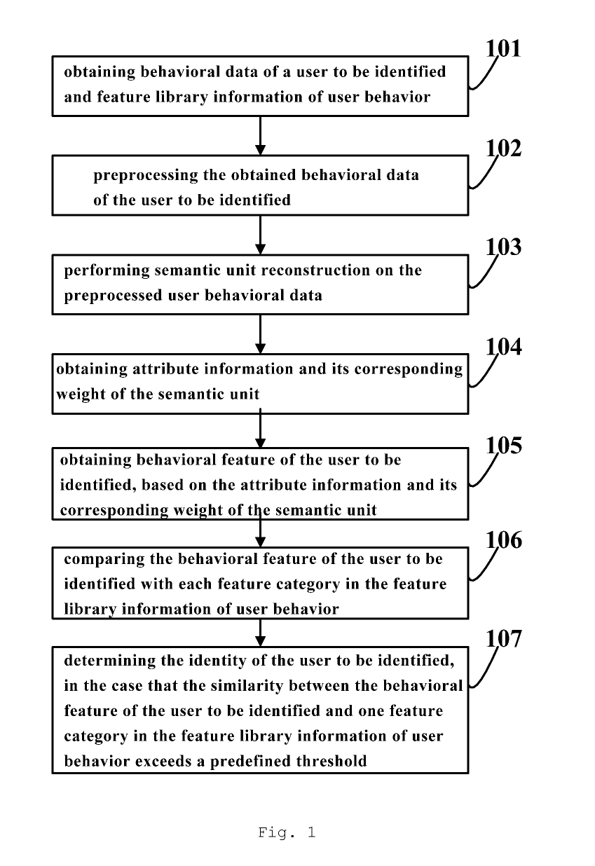

FIG. 1 shows a method for identifying microblog user identity according to an exemplary embodiment of the present disclosure, which comprises the following steps:

Step 101: obtaining behavioral data of a user to be identified and feature library information of user behavior.

Step 102: preprocessing the obtained behavioral data of the user to be identified. The preprocessing mainly includes: behavioral data filtering, spelling correction, word segmentation, part-of-speech tagging and the like.

Step 103: performing semantic unit reconstruction on the preprocessed user behavioral data. The semantic unit reconstruction may be achieved by applying part-of-speech information on a basis of the preprocessing so as to perform word adhesion. By combining specific words, a semantic unit (word string) with more rich semantic content may be constructed.

Step 104: obtaining attribute information and its corresponding weight of the semantic unit. For example, the attribute information of the semantic unit may comprise statistical word frequency and document frequency for respective semantic unit. With respect to the weight of the semantic unit, TFIDF function may be adopted to calculate the weight value of the user behavioral feature, so as to obtain the numeric value for the user behavioral feature.

Step 105: obtaining behavioral feature of the user to be identified, based on the attribute information and its corresponding weight of the semantic unit. The behavioral feature of the user to be identified may comprise an exacted feature which best represents the user behaviour, and the feature item (i.e., the semantic unit) has a good discrimination. For a single user to be identified, mainly by a method based on a combination of word weight, word frequency and part-of-speech, key word ranking may be performed according to word weight and word frequency, stop words or non-stop words (whose length is either more than the largest length or less than the smallest length) may be filtered off according to a list of stop words, and a word whose part-of-speech is “a”, “cw”, “v”, “j”, “ns”, “nr”, “nt” or “nz”, or which comprises the word “ [symbol] (no)” may be selected.

Step 106: comparing the behavioral feature of the user to be identified with each feature category in the feature library information of user behaviour. The comparing may comprise classifying the user mainly by adopting a KNN algorithm, where K value is selected by a method of probability distribution, i.e., a ratio of a similarity feature vector to the feature vector space. A specific method for the classifying may comprise: obtaining a similarity sim(u,C) between the user to be identified and each user category in the feature library information of user behaviour; obtaining a similarity sim(u,Cui) between the user to be identified and a user contained in each category; if the sim(u,C) is larger than a experiential threshold, or most of the sim(u,Cui) are larger than a experiential threshold, it is considered that the user to be identified has a relevancy to this category; selecting a user category with the largest similarity so as to determine the user identity.

The similarity between the feature vectors may be calculated by using a measuring method based on the adjusted cosine similarity, which comprises, for example, the following specific steps:

(1) for each feature vector in the feature vector library, calculating its similarity with this user feature vector;

(2) performing vector alignment operation, e.g., for vectors v1 and v2, calculating a union C(v1, v2) of all feature items, and then mapping v1 and v2 to C, so as to obtain new vectors v1′ and v2′;

(3) calculating the similarity of v1′ and v2′ with the calculation formula for the adjusted cosine similarity.

Step 107: determining the identity of the user to be identified, in the case that the similarity between the behavioral feature of the user to be identified and one feature category in the feature library information of user behavior exceeds a predefined threshold.

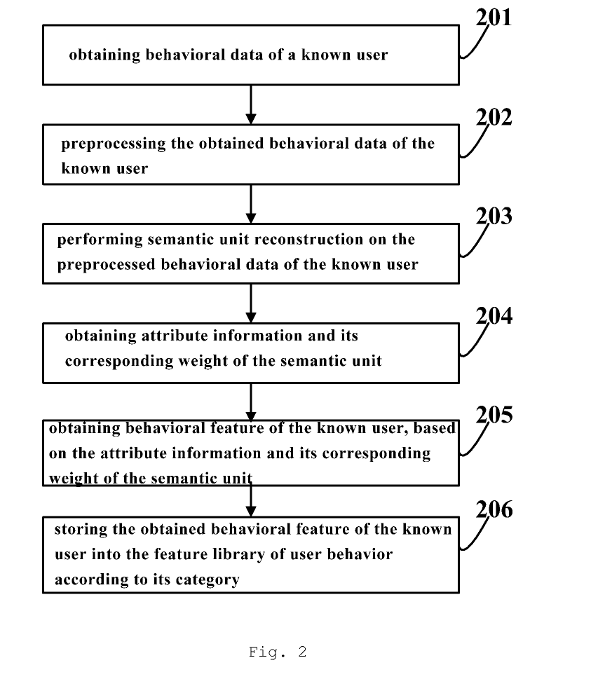

In one implementation of the method for identifying microblog user identity according to the exemplary embodiment of the present disclosure as described above, prior to the above-described step 101 of obtaining behavioral data of a user to be identified and feature library information of user behavior, the method may further comprise a process of constructing the feature library of the user behavior. FIG. 2 shows a flowchart for constructing a feature library of user behavior in a method for identifying microblog user identity according to embodiments of the present disclosure, which constructing process may comprise:

Step 201: obtaining behavioral data of a known user. Specifically, the behavioral data of a known user is obtained as training data. The training data is used to construct the feature library of user behavior.

Step 202: preprocessing the obtained behavioral data of the known user. Specifically, according to the corresponding identity of the known user, the training data (i.e., known user data) is tagged. Microblog message of each of users with the same identity is filtered by comparing the length of the message with an observed value (θ=10 in this system, because through the statistic analysis for a numerous microblog messages, a microblog message only consisting of less than 10 characters normally contains little or no semantic information), and if the length is less than the observed value, this microblog, as noise, is filtered off. Spelling check may mainly comprise spelling correction according to a common spelling errors table. Word segmentation and part-of-speech tagging may be achieved by using word segmentation and part-of-speech tagging tools. After such processing, each word contains word string information and part-of-speech. The word segmentation and part-of-speech tagging tools may be well-known techniques in the art, and thus their description will be omitted.

Step 203: performing semantic unit reconstruction on the preprocessed behavioral data of the known user. Since a longer word string contains more semantic information and has a stronger expression ability, as compared with a shorter word string, the semantic unit reconstruction may comprise: on a basis of the result of step 201, performing word adhesion on the adjacent specific words according to a specific rule, so as to create a longer semantic string. The adjacent words to be processed in this step comprise “ns” placename, “nr” person name, “nt” organization name, “nz” proper noun, “j” abbreviation and so on. The processing rule comprises combining all sequential words between the first word of this type to the last word of this type. The part-of-speech of the combined word string is tagged as “cw”, and such combined word is more important in selecting the feature and calculating the weight.

Step 204: obtaining attribute information and its corresponding weight of the semantic unit.

Obtaining the attribute information of the semantic unit may comprise: on a basis of step 201 and step 202, uniformly numbering the semantic units; creating index vector of microblog-semantic unit; performing statistics for the attribute information of the semantic unit according to the user, including word frequency and document frequency, so as to be prepared for extracting single user behavioral feature; performing statistics for word frequency and document frequency according to the user with a same identity, so as to be prepared for extracting category behavioral feature of the same identity category; as the result of these processing, information is stored in the data structure as shown in FIG. 6.

Obtaining the weight of the semantic unit may comprise:

Firstly, stop words may be filtered off based on a stop words list commonly used in the natural language processing field, and semantic unit whose word frequency is less than experimental threshold and whose part-of-speech does not comprise “n”, “cw” may be filtered off. Secondly, weight value of each semantic unit may be calculated by a calculating method based on TF-IDF weight value, which gives higher weight to specific type of semantic unit. Specifically, for the part-of-speech of “nr” person name, as shown in the following equation (2), weighting coefficient α=2.0, and for the part-of-speech of “cw” combined word, as shown in the following equation (3), weighting coefficient β=1.5. The specific weighting calculation equations are as follow:

weight1=TF|log₂IDF (1)

weight2=2.0|TF|log₂IDF (2)

weight3=1.5|TF|log₂IDF (3)

Step 205: obtaining behavioral feature of the known user, based on the attribute information and its corresponding weight of the semantic unit. The obtaining step may comprise:

For the obtained training data of the known user identity, a method based on the combination of chi-square statistics, part-of-speech and word frequency may be adopted. Firstly, a chi-square value corresponding to the user category of each semantic unit may be calculated, and the semantic units may be ranked according to their chi-square values. The word whose length is equal to 1 and whose part-of-speech is non-nr may be filtered off. Stop words or non-stop words (whose length is either more than the largest length or less than the smallest length) may be filtered off according to a list of stop words; a word whose part-of-speech is “a”, “cw”, “v”, “j”, “ns”, “nr”, “nt”, “nz”, or which comprises the word “ [symbol] (no)” may be selected. If the above information cannot be discriminated, the semantic unit with larger word frequency is selected.

In order to control the dimensionality of the feature in the classifying, the maximum number of the selected semantic units may be set as θ=200.

Step 206: storing the obtained behavioral feature of the known user into the feature library of user behavior according to its category.

In one implementation of the method for identifying microblog user identity according to the exemplary embodiment of the present disclosure as shown in FIG. 1, after the above-described step 107 of determining the identity of the user to be identified, the method may further comprise: updating the feature library of user behavior. FIG. 3 shows a flowchart for updating the feature library of user behavior in the method for identifying microblog user identity according to the present disclosure, which comprises:

Step 301: obtaining at least one semantic unit of the user to be identified whose identity has been determined, and user category information corresponding to the identity of the user.

Step 302: comparing the semantic units with the user category information corresponding to the identity of the user, and obtaining a similarity between each of the semantic units and the user category information corresponding to the identity of the user. This step may adopt chi-square statistics method, which calculates a chi-square value between the semantic unit and the user category, and evaluates the relevancy based on the obtained chi-square value.

Step 303: ranking the semantic units in descending order of the similarities.

Step 304: obtaining semantic units with top-n similarities as the behavioral feature of this category of the user.

Step 305: adding the behavioral feature of the user into the corresponding category of the feature library of user behavior.

It should be noted that, the behavioral feature as mentioned in the above embodiments at least comprises one semantic unit; as shown in FIG. 6, attribute information of the semantic unit at least comprises: index value, character information, part-of-speech, word frequency and document frequency; the semantic unit at least comprises one word; the attribute information of the word comprises: index of the word, word frequency, document frequency, IDF value, weight value.

The pre-processing step mainly comprises: behavioral data filtering, spelling correction, word segmentation and part-of-speech tagging.

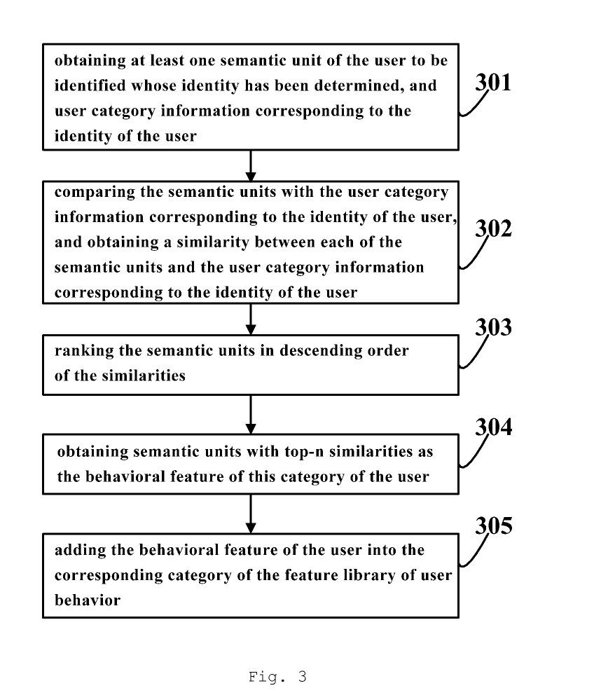

FIG. 4 shows a system for identifying microblog user identity according to an exemplary embodiment of the present disclosure, which comprises:

information obtaining unit 401, configured for obtaining behavioral data of a user to be identified and feature library information of user behavior;

preprocessing unit 402, configured for preprocessing the obtained behavioral data of the user to be identified;

semantic unit reconstruction unit 403, configured for performing semantic unit reconstruction on the preprocessed user behavioral data;

attribute and weight information obtaining unit 404, configured for obtaining attribute information and its corresponding weight of the semantic unit;

behavioral feature extracting unit 405, configured for obtaining behavioral feature of the user to be identified, based on the attribute information and its corresponding weight of the semantic unit;

comparing unit 406, configured for comparing the behavioral feature of the user to be identified with each feature category in the feature library information of user behavior;

identity determining unit 407, configured for determining the identity of the user to be identified, in the case that the similarity between the behavioral feature of the user to be identified and one feature category in the feature library information of user behavior exceeds a predefined threshold.

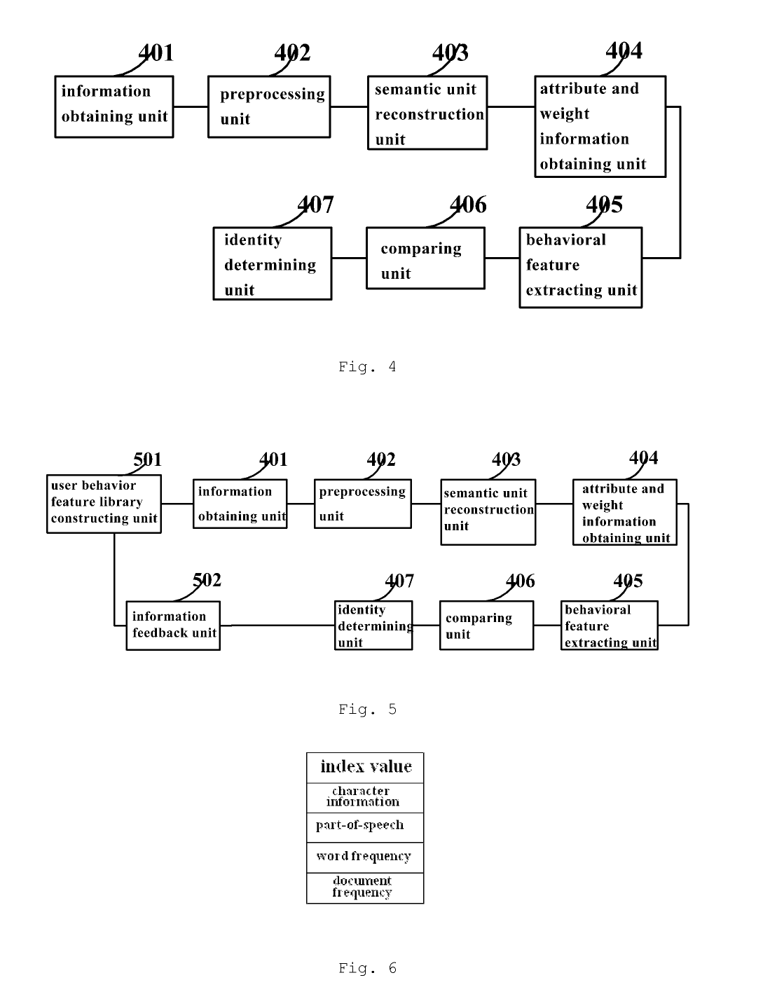

Please note that, as shown in FIG. 5, the system may further comprise: user behavior feature library constructing unit 501 and/or information feedback unit 502.

The user behavior feature library constructing unit 501 may be configured for: obtaining behavioral data of a known user; preprocessing the obtained behavioral data of the known user; performing semantic unit reconstruction on the preprocessed behavioral data of the known user; obtaining attribute information and its corresponding weight of the semantic unit; obtaining behavioral feature of the known user, based on the attribute information and its corresponding weight of the semantic unit; storing the obtained behavioral feature of the known user into the feature library of user behavior according to its category.

The information feedback unit 502 may be configured for: obtaining at least one semantic unit of the user to be identified whose identity has been determined, and user category information corresponding to the identity of the user; comparing the semantic units with the user category information corresponding to the identity of the user, and obtaining a similarity between each of the semantic units and the user category information corresponding to the identity of the user; ranking the semantic units in descending order of the similarities; obtaining semantic units with top-n similarities as the behavioral feature of this category of the user; adding the behavioral feature of the user into the corresponding category of the feature library of user behavior.

The above-mentioned behavioral feature at least comprises one semantic unit; the attribute information of the semantic unit at least comprises: index value, character information, part-of-speech, word frequency and document frequency; the semantic unit at least comprises one word; the attribute information of the word comprises: index of the word, word frequency, document frequency, IDF value, or weight value.

The above preprocessing operation mainly comprises: behavioral data filtering, spelling correction, word segmentation and part-of-speech tagging.

In the present disclosure, the provided method and system for identifying the microblog user identity obtain behavioral data of a user to be identified and feature library information of user behavior; preprocess the obtained behavioral data of the user to be identified; perform semantic unit reconstruction on the preprocessed user behavioral data; obtain attribute information and its corresponding weight of the semantic unit; obtain behavioral feature of the user to be identified, based on the attribute information and its corresponding weight of the semantic unit; compare the behavioral feature of the user to be identified with each feature category in the feature library information of user behavior; determine the identity of the user to be identified, in the case that the similarity between the behavioral feature of the user to be identified and one feature category in the feature library information of user behavior exceeds a predefined threshold. Using the provided method and system for identifying the microblog user identity, the accuracy and real-time performance of identifying the microblog user identity may be effectively improved.

One or more computer readable media having computer executable instructions contained therein are further provided in this disclosure, when executed on a computer, the instructions executing a method for identifying microblog user identity, the method comprising: obtaining behavioral data of a user to be identified and feature library information of user behavior; preprocessing the obtained behavioral data of the user to be identified; performing semantic unit reconstruction on the preprocessed user behavioral data; obtaining attribute information and its corresponding weight of the semantic unit; obtaining behavioral feature of the user to be identified, based on the attribute information and its corresponding weight of the semantic unit; comparing the behavioral feature of the user to be identified with each feature category in the feature library information of user behavior; determining the identity of the user to be identified, in the case that the similarity between the behavioral feature of the user to be identified and one feature category in the feature library information of user behavior exceeds a predefined threshold.

A computer provided with one or more computer readable media having computer executable instructions contained therein is further provided in this disclosure, when executed by the computer, the instructions implementing the above method for identifying microblog user identity.

Exemplary Operating Environment

The computer or computing device as described herein comprises hardware, including one or more processors or processing units, system memory and some types of computer readable media. By way of example and not limitation, computer readable media comprise computer storage media and communication media. Computer storage media comprises volatile or nonvolatile, removable or non-removable media implemented in any method or technology for storage of information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

The computer may use one or more remote computers, such as logical connections to remote computers operated in a networked environment. Although various embodiments of the present disclosure are described in the context of the exemplary computing system environment, various embodiments of the present disclosure may be used with numerous other general purpose or application specific computing system environments or configurations. The computing system environment is not intended for limiting any aspect of the scope of use or functionality of the invention. In addition, the computer environment should not be interpreted as depending on or requiring any one or combination of components shown in the exemplary operating environment. Well-known examples of the computing systems, the environment and/or configurations suitable for all aspects of the present disclosure include, but are not limited to: personal computers, server computers, handheld or laptop devices, multiprocessor systems, microprocessor-based systems, set top boxes, programmable consumer electronics, mobile phone, network PC, minicomputers, mainframe computers, distributed computing environments including any one of the above systems or devices, and so on.

Various embodiments of the invention may be described in a general context of computer executable instructions such as program modules executed on one or more computers or other devices. The computer-executable instructions may be organized into one or more computer-executable components or modules as software. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein. Aspects of the invention may also be practiced in distributed computing environments where tasks are performed by remote processing devices that are linked through a communications network. In a distributed computing environment, program modules may be located in both local and remote computer storage media including memory storage devices.

It is possible to carry out the method and apparatus of the present invention in many ways. For example, it is possible to carry out the method and apparatus of the present invention through software, hardware, firmware or any combination thereof. The above described order of the steps for the method is only intended to be illustrative, and the steps of the method of the present invention are not limited to the above specifically described order unless otherwise specifically stated. Besides, in some embodiments, the present invention may also be embodied as programs recorded in recording medium, including machine-readable instructions for implementing the method according to the present invention. Thus, the present invention also covers the recording medium which stores the program for implementing the method according to the present invention.

Those skilled in the art would understand that, all or part of the steps in the above exemplary methods can be achieved by a program instructing the corresponding hardware, wherein said program may be stored in a computer readable storage medium, and when executed, may achieve the steps of the above-described methods for identifying microblog user identity. The storage medium may be, for example: ROM/RAM, magnetic disk, or optical disk, etc.

Some specific embodiments have been described above only by the way of examples, but would not limit the protection scope of the present invention. Those skilled in the art may readily make any modification and variation to the invention without departing from the spirit and scope of the invention, and such modifications and variations of the invention would be encompassed within the protection scope of the invention. The scope of the present invention is defined by the attached claims.

1. A method for identifying microblog user identity, comprising steps of:
obtaining behavioral data of a user to be identified and feature library information of user behavior;
preprocessing the obtained behavioral data of the user to be identified;
performing semantic unit reconstruction on the preprocessed user behavioral data;
obtaining attribute information and its corresponding weight of the semantic unit;
obtaining behavioral feature of the user to be identified, based on the attribute information and its corresponding weight of the semantic unit;
comparing the behavioral feature of the user to be identified with each feature category in the feature library information of user behavior;
determining the identity of the user to be identified, in the case that the similarity between the behavioral feature of the user to be identified and one feature category in the feature library information of user behavior exceeds a predefined threshold.

2. The method according to claim 1, wherein, prior to the step of obtaining behavioral data of a user to be identified and feature library information of user behavior, the method further comprises:
obtaining behavioral data of a known user;
preprocessing the obtained behavioral data of the known user;
performing semantic unit reconstruction on the preprocessed behavioral data of the known user;
obtaining attribute information and its corresponding weight of the semantic unit;
obtaining behavioral feature of the known user, based on the attribute information and its corresponding weight of the semantic unit;
storing the obtained behavioral feature of the known user into the feature library of user behavior according to its category.

3. The method according to claim 1, wherein, after determining the identity of the user to be identified, the method further comprises:
obtaining at least one semantic unit of the user to be identified whose identity has been determined, and user category information corresponding to the identity of the user;
comparing the semantic units with the user category information corresponding to the identity of the user, and obtaining a similarity between each of the semantic units and the user category information corresponding to the identity of the user;
ranking the semantic units in descending order of the similarities;
obtaining semantic units with top-n similarities as the behavioral feature of this category of the user;
adding the behavioral feature of the user into the corresponding category of the feature library of user behavior.

4. The method according to claim 3, wherein, the behavioral feature at least comprises one semantic unit; the attribute information of the semantic unit at least comprises: index value, character information, part-of-speech, word frequency and document frequency; the semantic unit at least comprises one word; the attribute information of the word comprises: index of the word, word frequency, document frequency, IDF value, or weight value.

5. The method according to claim 4, wherein, the step of preprocessing comprises: behavioral data filtering, spelling correction, word segmentation and part-of-speech tagging.

6. A system for identifying microblog user identity, comprising:
information obtaining unit, configured for obtaining behavioral data of a user to be identified and feature library information of user behavior;
preprocessing unit, configured for preprocessing the obtained behavioral data of the user to be identified;
semantic unit reconstruction unit, configured for performing semantic unit reconstruction on the preprocessed user behavioral data;
attribute and weight information obtaining unit, configured for obtaining attribute information and its corresponding weight of the semantic unit;
behavioral feature extracting unit, configured for obtaining behavioral feature of the user to be identified, based on the attribute information and its corresponding weight of the semantic unit;
comparing unit, configured for comparing the behavioral feature of the user to be identified with each feature category in the feature library information of user behavior;
identity determining unit, configured for determining the identity of the user to be identified, in the case that the similarity between the behavioral feature of the user to be identified and one feature category in the feature library information of user behavior exceeds a predefined threshold.

7. The system according to claim 6, wherein, the system further comprises user behavior feature library constructing unit, configured for:
obtaining behavioral data of a known user;
preprocessing the obtained behavioral data of the known user;
performing semantic unit reconstruction on the preprocessed behavioral data of the known user;
obtaining attribute information and its corresponding weight of the semantic unit;
obtaining behavioral feature of the known user, based on the attribute information and its corresponding weight of the semantic unit;
storing the obtained behavioral feature of the known user into the feature library of user behavior according to its category.

8. The system according to claim 6, wherein, the system further comprises information feedback unit, configured for:
obtaining at least one semantic unit of the user to be identified whose identity has been determined, and user category information corresponding to the identity of the user;
comparing the semantic units with the user category information corresponding to the identity of the user, and obtaining a similarity between each of the semantic units and the user category information corresponding to the identity of the user;
ranking the semantic units in descending order of the similarities;
obtaining semantic units with top-n similarities as the behavioral feature of this category of the user;
adding the behavioral feature of the user into the corresponding category of the feature library of user behavior.

9. The system according to claim 8, wherein, the behavioral feature at least comprises one semantic unit; the attribute information of the semantic unit at least comprises: index value, character information, part-of-speech, word frequency and document frequency; the semantic unit at least comprises one word; the attribute information of the word comprises: index of the word, word frequency, document frequency, IDF value, or weight value.

10. The system according to claim 9, wherein, the preprocessing comprises: behavioral data filtering, spelling correction, word segmentation and part-of-speech tagging.
